(19) United States
(12) Patent Application Publication
(10) Pub. No.: US 2017/0124675 A1
(43) Pub. Date: May 4, 2017

(54) SYSTEM AND METHOD FOR QUANTIFYING FRAUDULENT OVERCHARGES AND PENALTIES IN A CLAIM STATEMENT

(71) Applicants: Nicholas E. Bruce, Castro Valley, CA (US); Richard C. Knudsen, Pleasanton, CA (US)

(72) Inventors: Nicholas E. Bruce, Castro Valley, CA (US); Richard C. Knudsen, Pleasanton, CA (US)

(21) Appl. No.: 15/333,511

(22) Filed: Oct. 25, 2016

Related U.S. Application Data
(60) Provisional application No. 62/247,300, filed on Oct. 28, 2015.

(51) Int. Cl. G06Q 50/26; G06Q 30/00

(52) U.S. Cl. CPC G06Q 50/26; G06Q 30/0185

(57) ABSTRACT

A system and computer implemented method for quantifying fraudulent overcharges and penalties in a claim statement comprises a memory unit to store a database comprising metadata pertaining to at least one contract. Further, the memory unit comprises a set of program modules. The set of program modules comprises a parser module, a model generator module, a fraud detection module, and a quantifier module. The parser module is configured to parse the contract into at least one claim string, and parse the claim statement into plurality of monetary charges. The model generator module is configured to generate one or more preliminary metrics associated with at least one claim string based on evaluation and to generate an optimal monetary charge. The quantifier module, is configured to generate a fraudulent charge metric representing the plurality of monetary charges, based on the plurality of monetary charges being the fraudulent charge.

### CROSS REFERENCE TO RELATED APPLICATION

This application claims the benefit of U.S. Provisional Application No. 62/247,300 filed on Oct. 28, 2015.

### BACKGROUND OF THE INVENTION

A. Technical Field

The present invention generally relates to the technical field of computer based fraud analysis, and more specifically relates to a system and method for quantifying fraudulent overcharges and penalties in a claim statement.

B. Description of Related Art

The Federal General Services Administration (GSA) schedules program offers several products, supplies, and professional services for a plurality of government organizations. The plurality of government organizations include, but is not limited to Quasi-Government Organizations, State government organizations, County government organizations, City government organizations, public housing authorities, school districts, Public colleges, Universities, Indian Tribal governments. Typically, GSA negotiates with a contractor to receive products, supplies, and professional services at a price identical to price charged by the contractor to a most favored commercial customer of the contractor. Further, the contractor and the GSA sign in a contract with provisions with respect to price chargeable by the contractor for delivering products, supplies, and professional services. However, as often is the case, the contractors fraudulently overcharge the GSA to derive income via malicious means. The fraudulent charges are often interspersed with contractually valid charges, in a claim statement. Examples of the claim statement includes but is not limited to invoices, billing payments, reports, account reviews, statement of works, and mobile services data plans. The GSA employs multiple systems to minimize amount of fraudulent charges in the claim statement.

In one example, a computer implemented system assesses potential fraud of an insurance claim, mortgage loans, banking transactions, and health care billing and generates a report indicating fraud potentials to an assigned investigator. However, the computer implemented system has a serious drawback. The computer implemented system fails to precisely quantify fraudulent charges in a claim statement. The computer implemented system fails to quantify fraudulent overcharges and penalties charges by the contractor after analyzing both the contract and the claim statement. Further, the computer implemented system fail to account for dependencies between one or more claim strings in the contract.

Therefore, there is a need in the art for a system having a feature of quantifying fraudulent overcharges and penalties charges by the contractor after analyzing both the contract and the claim statement.

### SUMMARY OF THE INVENTION

The present invention relates to a system and method for quantifying fraudulent overcharges and penalties in a claim statement

In one embodiment of the present invention, a system for quantifying fraudulent overcharges and penalties in a claim statement comprises a memory unit to store a database comprising metadata pertaining to at least one contract. Further, the database comprises a set of program modules. The metadata comprises information regarding dependencies between at least one opportunity and one or more provisions in at least one contract, and dependencies between the one or more claim strings in at least one contract. Furthermore, the system comprises a processor to execute the set of program modules. The set of program modules comprises a parser module, a model generator module, a fraud detection module, and a quantifier module. The parser module is configured to parse the contract into at least one claim string. Further, the parser module is configured to parse the claim statement into a plurality of monetary charges. The model generator module is configured to analyze at least one claim string based on the metadata pertaining to at least one contract.

Further, the model generator module is configured to generate one or more preliminary metrics associated with at least one claim string based on analysis. Further, the model generator module is configured to generate a mathematical model of the one or more provisions of at least one contract, based on the one or more preliminary metrics. Further, the model generator module is configured to generate a set of optimal monetary charges corresponding to the plurality of monetary charges, based on the mathematical model. The fraud detection module, is configured to categorize at least one monetary charge among the plurality of monetary charges as one of fraudulent charge and non-fraudulent charge based on at least one monetary charge exceeding the optimal monetary charge. The quantifier module, is configured to generate a fraudulent charge metric representing the plurality of monetary charges, based on the plurality of monetary charges being the fraudulent charge.

In another embodiment of the present invention, the opportunity is at least one a business deal, product, a distribution channel, a customer service, a building lease, and a logistics service. In yet another embodiment of the present invention, the one or more provisions comprise at least one of penalties, monetary charges, term of contract, name of parties, a description origin, a compliance origin, structured information pertaining to at least one contract, unstructured information pertaining to at least one contract, comparisons between the one or more provisions, a value model field, a compliance filter trigger, a false claim model filter, a damages scenarios model. In yet another embodiment of the present invention, the claim statement is at least one of invoices, billing payments, reports, account reviews, statement of works, and mobile or cellular plans. In yet another embodiment of the present invention, the system comprises a mathematical analyzer module configured to analyze portfolio effects based on the dependencies between the one or more claim strings in at least one contract, and false claim compliance law effects based on the fraudulent charge metric. In yet another embodiment of the present invention, the model generator module identifies at least one preliminary metric representing dependencies between at least one opportunity and one or more provisions in at least one contract. In yet another embodiment of the present invention, dependencies between the one or more claim strings in at least one contract are at least one of a constraint-type dependency and a dependence-type dependency.

In yet another embodiment of the present invention, the model generator module formulates at least one dependency between the one or more claim strings in at least one contract, based on the mathematical model. In yet another embodiment of the present invention, the set of program modules are implemented in a network of Application Specific Integrated Circuit (ASIC) Chipsets in the system.

In one embodiment of the present invention, a computer implemented method of quantifying fraudulent overcharges and penalties in a claim statement, comprises storing metadata pertaining to at least one contract in a computer system. The metadata comprises information pertaining to dependencies between at least one opportunity and one or more provisions in at least one contract, and dependencies between the one or more claim strings in at least one contract. Further, the method comprises parsing, by a processor via a parser module, the contract into at least one claim string. Moreover, the method comprises parsing, by the processor via the parser module, the claim statement into plurality of monetary charges. Furthermore, the method comprises analyzing, by the processor via a model generator module, at least one claim string based on the metadata pertaining to at least one contract. Moreover, the method comprises generating, by the processor via the model generator module, one or more preliminary metrics associated with at least one claim string based on analysis. Moreover, the method comprises generating, by the processor via the model generator module, a mathematical model of the one or more provisions of at least one contract, based on the one or more preliminary metrics. Further, the method comprises generating, by the processor via the model generator module, an optimal monetary charge, based on the mathematical model. Further, the method comprises categorizing, by the processor via a fraud detection module, the plurality of monetary charges as one of fraudulent charge and genuine charge, based on the plurality of monetary charges exceeding the optimal monetary charge. Further, the method comprises generating, by the processor via a quantifier module, a fraudulent charge metric representing the plurality of monetary charges, based on the plurality of monetary charges being the fraudulent charge.

In one embodiment of the present invention, a non-transitory program storage device readable by computer, and comprising a program of instructions executable by a processor to perform a computer implemented method of quantifying fraudulent overcharges and penalties in a claim statement, comprises storing metadata pertaining to at least one contract in a computer system. The metadata comprises information pertaining to dependencies between at least one opportunity and one or more provisions in at least one contract, and dependencies between the one or more claim strings in at least one contract. Further, the method comprises parsing, by a processor via a parser module, the contract into at least one claim string. Moreover, the method comprises parsing, by the processor via the parser module, the claim statement into plurality of monetary charges. Furthermore, the method comprises analyzing, by the processor via a model generator module, at least one claim string based on the metadata pertaining to at least one contract. Moreover, the method comprises generating, by the processor via the model generator module, one or more preliminary metrics associated with at least one claim string based on analysis. Moreover, the method comprises generating, by the processor via the model generator module, a mathematical model of the one or more provisions of at least one contract, based on the one or more preliminary metrics. Further, the method comprises generating, by the processor via the model generator module, an optimal monetary charge, based on the mathematical model. Further, the method comprises categorizing, by the processor via a fraud detection module, the plurality of monetary charges as one of fraudulent charge and genuine charge, based on the plurality of monetary charges exceeding the optimal monetary charge. Further, the method comprises generating, by the processor via a quantifier module, a fraudulent charge metric representing the plurality of monetary charges, based on the plurality of monetary charges being the fraudulent charge.

### BRIEF DESCRIPTION OF DRAWINGS

FIG. 1 is a block diagram of an environment implemented in accordance with various embodiments of the invention.

FIG. 2 is a block diagram of a system for quantifying fraudulent overcharges and penalties in a claim statement, according to another embodiment of the present invention.

FIG. 3 is flow chart of a computer-implemented method of quantifying fraudulent overcharges and penalties in a claim statement, according to yet another embodiment of the present invention.

FIG. 4 is a screenshot view of a claim statement according to yet another embodiment of the present invention.

FIG. 5 is a screenshot view of a fraudulent charge metric screen according to yet another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

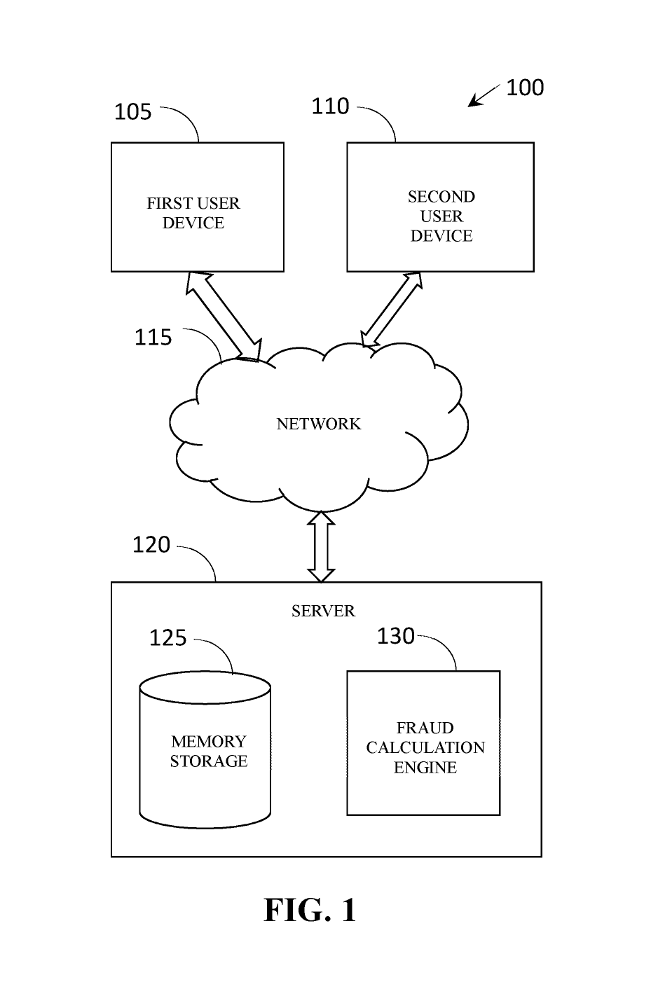

FIG. 1 is a block diagram of an environment 100 in accordance with which various embodiments of the present invention are implemented. The environment 100 comprises a first user device 105, a second user device 110, a network 115, and a server 120. The first user device 105 and the second user device 110 are at least one of tablet computers, personal computers, smart phones, smart televisions and laptops. In one embodiment of the present invention, the first user device 105 and the second user device 110 comprises a document scanner. Examples of the document scanners comprises a Contact Image Sensor (CIS) Scanner, a Charge Coupled Device (CCD) scanner, and a smartphone scanner. A user is enabled to scan a claim statement via at least one of the first user device 105 and the second user device 110. The claim statement is at least one of invoices, billing payments, reports, account reviews, statement of works, IT professional services, monthly invoices, services optimization reports, utilization reports, account reviews and recommendations, stewardship reports, statement of works and pricing audits. In one example, at least one of the first user device 105 and the second user device 110 enable the user to communicate with the server 120 via the network 115. The network 115 is at least one of a mobile network, a wide area network and a wireless radio network. The server 120 is at least one of a file server, a database server, a communications server, an applications server, a cloud server, and a domain server. The server 120 comprises a fraud calculation engine 130 and a memory unit 125. The memory unit 125 is at least one of a flash memory, magnetic tapes, optical discs, and floppy discs. The memory unit 125 comprises a database of metadata pertaining to at least one contract. The contract comprises description about an opportunity, one or more provisions pertaining to the contract and one or more claim strings representing the provisions. Examples of the opportunity includes, but is not limited to is at least one a business deal, product, a distribution channel, a customer service, a building lease, and a logistics service. Examples of the one or more provisions include, but is not limited to penalties, monetary charges, term of contract, name of parties, a description origin, a compliance origin, structured information pertaining to at least one contract, unstructured information pertaining to at least one contract, comparisons between the one or more provisions, a value model field, a compliance filter trigger, a false claim model filter, a damages scenarios model. Further, the database comprises one or more variables of a mathematical model of the contract and the business opportunity. The mathematical model of the contract represents value of the contract in terms of one or more metrics. The metadata pertaining to at least one contract comprises information regarding dependencies in the contract. The dependencies are restrictions placed on the one or more variables. The dependencies depend on face value of the one or more variables and the one or more metrics. The information regarding dependencies comprises a list of variables restricted by each dependency in the contract. The metadata comprises information regarding dependencies between at least one opportunity and one or more provisions in at least one contract, and dependencies between the one or more claim strings in at least one contract. The dependencies between the one or more claim strings in at least one contract are at least one of a constraint-type dependency and a dependence-type dependency. The constraint type dependencies restrict variables of the mathematical model of the contract into a range of potential values. The range of potential values is defined based on at least one of a variable of the mathematical model and a metric representing the mathematical model of the contract. The dependence type dependencies restrict variables of the mathematical model based on the one or more metrics.

Further, the memory unit 125 comprises a set of program modules, executable by a processor. The set of program modules comprises a parser module, a model generator module, a fraud detection module, a mathematical analyzer module, and a quantifier module. In one embodiment of the present invention, functionality of the set of program modules is implemented in a network of corresponding Application Specific Integrated Circuit (ASIC) Chipsets.

Further, the fraud calculation engine 130 is at least one of a Field Programmable Gate Array, a microprocessor, an Application Specific Integrated Circuit, a virtual machine, an interconnection of digital logic gates, a microcontroller, a microprocessor, a mainframe data processor, and a multicore processor. The fraud calculation engine 130 is configured to execute program modules stored in the memory unit 125. In one exemplary illustration of functioning of the present invention, the fraud calculation engine 130 quantifying fraudulent overcharges and penalties in a claim statement by executing the set of program modules stored in the memory unit 125. In one embodiment, the present invention is implemented as a website. In another embodiment, the present invention is implemented as a mobile application. In another embodiment, the present invention is implemented as a computer software. In another embodiment, the present invention is implemented as a software as a service. In another embodiment, the present invention is implemented as a cloud service.

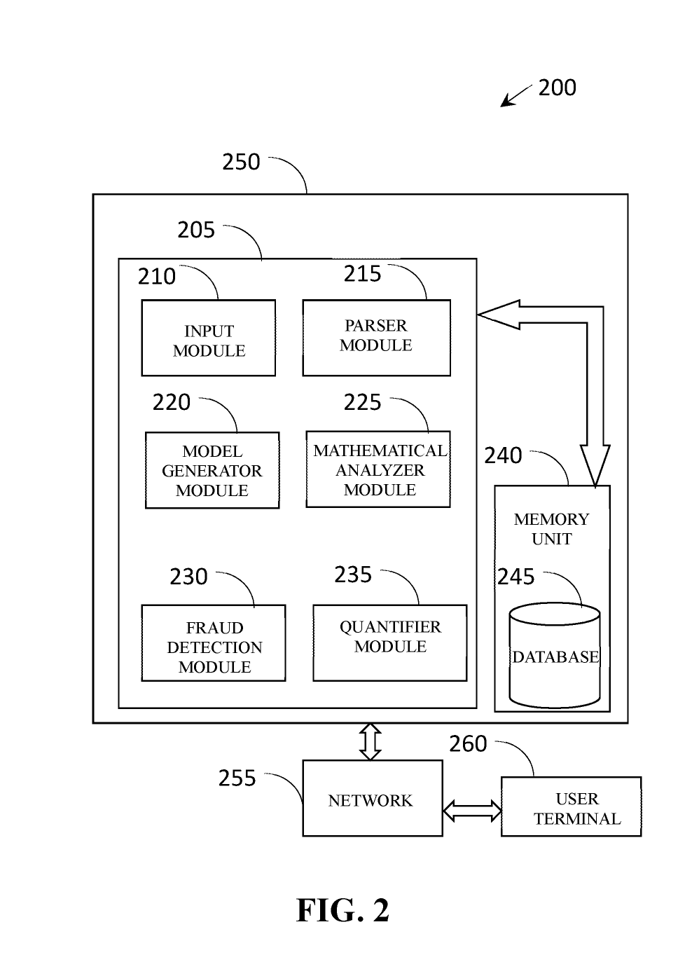

FIG. 2 is a block diagram of a system 200 for quantifying fraudulent overcharges and penalties in a claim statement, according to another embodiment of the present invention. The system 200 is implemented inside a device 250 connected to a network 255. In one embodiment of the present invention, the device 250 is a server. In another embodiment of the present invention, the device 250 is at least one of a laptop, a personal computer, a smart phone, a smart television, and a tablet computer. The network 255 is at least one of a Local Area Network, a Wide Area Network, a Wireless Network, a telecommunication network, a mobile network, and Internet. The network 255 enables the user to communicate with the device 250. The user is connected to the network 255 via a user terminal 260. The user terminal 260 is at least one of a laptop, a personal computer, a smart phone, a smart television, and a tablet computer. The user terminal 260 comprises a document scanner. Examples of the document scanners comprises a Contact Image Sensor (CIS) Scanner, a Charge Coupled Device (CCD) scanner, and a smartphone scanner. A user is enabled to scan a claim statement via the user terminal 260. The claim statement is at least one of invoices, billing payments, reports, account reviews, statement of works, IT professional services, monthly invoices, services optimization reports, utilization reports, account reviews and recommendations, stewardship reports, statement of works.

Further, the device 250 comprises a memory unit 240 and a fraud calculation engine 205. The memory unit 240 is at least one of a volatile memory, non-volatile memory, Read Only memory (ROM), Random Access Memory (RAM), and a flash memory. The memory unit 240 comprises a database 245. The database 245 comprises metadata pertaining to at least one contract. The contract comprises description about an opportunity, one or more provisions pertaining to the contract and one or more claim strings representing the provisions. Examples of the opportunity includes, but is not limited to is at least one a business deal, product, a distribution channel, a customer service, a building lease, and a logistics service. Examples of the one or more provisions include, but is not limited to penalties, monetary charges, term of contract, name of parties, a description origin, a compliance origin, structured information pertaining to at least one contract, unstructured information pertaining to at least one contract, comparisons between the one or more provisions, a value model field, a compliance filter trigger, a false claim model filter, a damages scenarios model. Further, the database 245 comprises one or more variables of a mathematical model of the contract and the business opportunity. The mathematical model of represents value of the contract in terms of one or more metrics. The metadata pertaining to at least one contract comprises information regarding dependencies in the contract. The dependencies are restrictions placed on the one or more variables. The dependencies depend on face value of the one or more variables and the one or more metrics. The information regarding dependencies comprises a list of variables restricted by each dependency in the contract. The metadata comprises information regarding dependencies between at least one opportunity and one or more provisions in at least one contract, and dependencies between the one or more claim strings in at least one contract. The memory unit 240 transmits the metadata to the fraud calculation engine 205.

The fraud calculation engine 205 is at least one of a processor, a Field Programmable Gate Array, a microprocessor, an Application Specific Integrated Circuit, a virtual machine, and an interconnection of digital logic gates. The fraud calculation engine 205 executes a set of program modules. The set of program modules comprises an input module 210, a parser module 215, a model generator module 220, a mathematical analyzer module 225, a fraud detection module 230, and a quantifier module 235. In one embodiment of the present invention, source code for the set of program modules is stored in the memory unit 240. In another embodiment of the present invention, functionality of the set of program modules is implemented in a network of corresponding Application Specific Integrated Circuit (ASIC) Chipsets configured inside the fraud calculation engine 205.

The input module 210 is configured to receive the claim statement. In one embodiment of the present invention, input module 210 communicates with the document scanner in the user terminal 260. It is noted that the claim statement is at least one of invoices, billing payments, reports, account reviews, statement of works, IT professional services, monthly invoices, services optimization reports, utilization reports, account reviews and recommendations, stewardship reports, statement of works. In one embodiment, the claim statement pertains to monetary charges payable by a first party to a second party in view of at least one contract. It is noted that the metadata associated with at least one contract is stored in the database 245. The input module 210 is configured to retrieve the metadata from the database 245.

In one exemplary illustration of the present invention, the claim statement is an invoice for the performance of a professional service by the second party for the first party. As noted above, the second party performs the professional service on basis of at least one contract. The input module 210 retrieves the metadata from the database 245. The metadata comprises description about the professional service, and one or more provisions pertaining to the performance of the professional service. Examples of the one or more provisions include, but is not limited to penalties for delay, monetary charges, term of contract, name of parties, a description origin, and a compliance origin. In one example, the input module 210 receives the claim statement via at least one of a microphone, a keyboard, a mouse pointer, and a video camera. The input module 210 receives the claim statement in form of at least one of a voice command, text command, a gesture based command and a mouse-click. The input module 210 transmits the claim statement and the metadata into the parser module 215.

In one embodiment of the present invention, the parser module 215 is implemented in Application Specific Integrated Circuit Chip. The parser module 215 receives the claim statement and the contract from the input module 210. The parser module 215 parses the contract into at least one claim string. In one example, at least one claim string comprises information pertaining to the contract. Further, the parser module 215 parses the claim statement into a plurality of monetary charges. The plurality of monetary charges comprises genuine charges, fraudulent overcharges, genuine penalties and fraudulent penalties. In one exemplary illustration, the plurality of monetary charges is demanded by the second party from the first party for the performance of a professional service. In one example, the parser module 215 is at least one of a LALR parser, an LR parser, an LL parser and a markup language parser. The parser module 215 transmits at least one claim string and the plurality of monetary charges into the model generator module 220.

In one embodiment of the present invention, the model generator module 220 is a digital signal processor. The model generator module 220 analyzes at least one claim string based on the metadata pertaining to at least one contract. Further, the model generator module 220 generates one or more preliminary metrics associated with at least one claim string based on analysis. Furthermore, the model generator module 220 generates a mathematical model of the one or more provisions of at least one contract, based on the one or more preliminary metrics. Moreover, the model generator module 220 generates a set of optimal monetary charges corresponding to each monetary charge among the plurality of monetary charges. The model generator module 220 generates the set of optimal monetary charges based on the mathematical model. Further, the model generator module 220 formulates at least one dependency between the one or more claim strings in at least one contract, based on the mathematical model. The model generator module 220 sends the formulated dependencies into the database 245 for storage. Further, the model generator module 220 identifies at least one preliminary metric representing dependencies between at least one opportunity and one or more provisions in at least one contract. The model generator module 220 transmits the plurality of monetary charges and the set of optimal monetary charges into the fraud detection module 230.

In one embodiment of the present invention, the model generator module 220 is implemented in Application Specific Integrated Circuit Chip. Further, the model generator module 220 analyses the metadata pertaining to at least one contract. It is noted that the contract comprises description about an opportunity, one or more provisions pertaining to the contract and one or more claim strings representing the provisions of the contract. In one embodiment, the model generator module 220 calculates the optimal monetary charge based on one or more provisions pertaining to the contract and one or more claim strings representing the provisions of the contract. The fraud detection module 230 compares each monetary charge among the plurality of monetary charges with a corresponding optimal monetary charge in the set of optimal monetary charges. Further, the fraud detection module 230 categorizes at least one monetary charge among the plurality of monetary charges as a fraudulent charge if at least one monetary charges exceeds a corresponding optimal monetary charge. The fraudulent charges comprise fraudulent overcharges and penalties. If the monetary charge is lesser than the corresponding optimal monetary charge, then the fraud detection module 230 categorizes the monetary charge as genuine. If the monetary charge is categorized as the fraudulent charge, the fraud detection module 230 transmits information regarding the fraudulent charge into the quantifier module 235 and the mathematical analyzer module 225.

The quantifier module 235 generates a fraudulent charge metric based on information regarding the fraudulent charges. It is noted that the fraudulent charges comprise fraudulent overcharges and penalties. As a result, the quantifier module 235 quantifies fraudulent overcharges and penalties in the claim statement. The mathematical analyzer module 225 calculates portfolio effects based on the dependencies between the one or more claim strings in at least one contract. Further, the mathematical analyzer module 225 calculates false claim law effects based on the fraudulent charge metric.

In one embodiment of the present invention, the mathematical analyzer module 225 analyzes billing statistics supplied by a provider. The provider is at least one of government level and commercial customers. The mathematical analyzer module 225 incorporates a first set of rules during analysis so as to identify possibility of fraudulent charges in the claim statement. Further, the mathematical analyzer module 225 develops a profile of a billing behavior of the provider and compares lowest cost alternatives from Government contractors and competitors. The mathematical analyzer module 225 uses rule filters to alert an auditor if the plurality of monetary charges in the claim statement falls outside of the set of optimal monetary charges. Further, the mathematical analyzer module 225 calculates false claim law effects based on set of rules. The set of rules comprise formulae to calculate false claim law effects. The system 200 enables a user to adjust the false claim calculation formula. Further, the system 200 generates estimated punitive penalties and punitive recoveries using the set of rules. In one example, the system 200 performs rate plan analysis and generates savings recommendations.

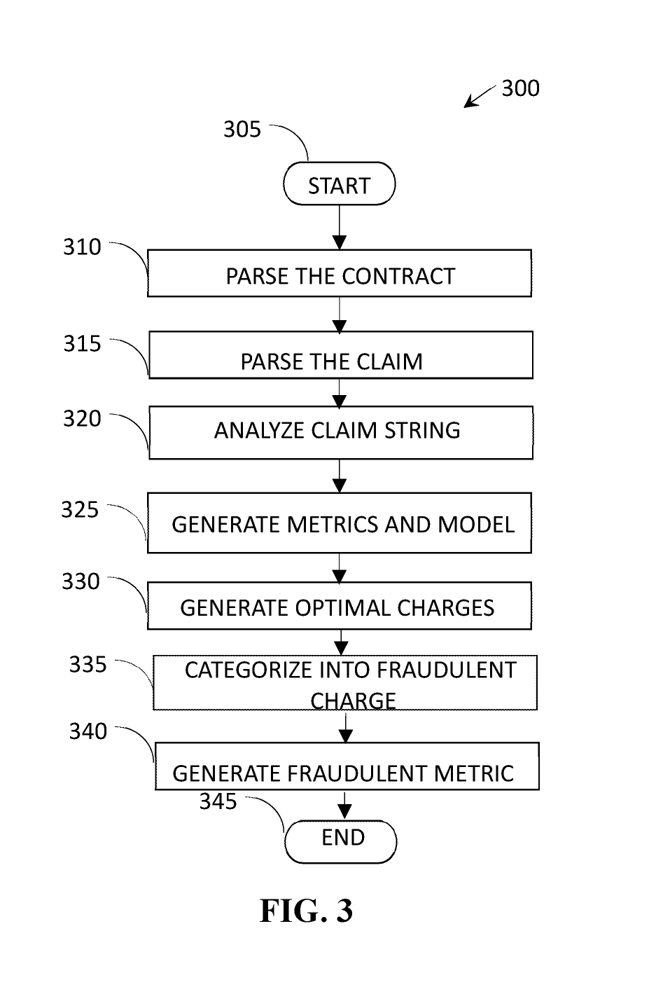

FIG. 3 is flow chart illustrating a computer-implemented method 300 of quantifying fraudulent overcharges and penalties in a claim statement, according to yet another embodiment of the present invention. The method 300 is implemented in a computer system comprising a memory unit and a processor. The memory unit stores a database comprising comprises a database. The database comprises metadata pertaining to at least one contract. The contract comprises description about an opportunity, one or more provisions pertaining to the contract and one or more claim strings representing the provisions. Examples of the opportunity includes, but is not limited to is at least one a business deal, product, a distribution channel, a customer service, a building lease, and a logistics service. Examples of the one or more provisions include, but is not limited to penalties, monetary charges, term of contract, name of parties, a description origin, a compliance origin, structured information pertaining to at least one contract, unstructured information pertaining to at least one contract, comparisons between the one or more provisions, a value model field, a compliance filter trigger, a false claim model filter, a damages scenarios model. Further, the database comprises one or more variables of a mathematical model of the contract and the business opportunity. The mathematical model of represents value of the contract in terms of one or more metrics. Moreover, the computer system comprises a processor. The method 300 commences at step 305.

At step 310 the contract is parsed into at least one claim string by the processor via a parser module. In one example, at least one claim string comprises information pertaining to the contract. In another example, one claim string comprises information pertaining to a statement by a party.

At step 315 the claim statement is parsed into a plurality of monetary charges by the processor via the parser module. The plurality of monetary charges comprises genuine charges, fraudulent overcharges, genuine penalties and fraudulent penalties. In one exemplary illustration, the plurality of monetary charges is demanded by the second party from the first party for the performance of a professional service. In one example, the parser module is at least one of a LALR parser, an LR parser, an LL parser and a markup language parser.

At step 315 at least one claim string is analyzed, by the processor via a model generator module based on the metadata pertaining to at least one contract. The metadata pertaining to at least one contract comprises information regarding dependencies in the contract. The dependencies are restrictions placed on the one or more variables. The dependencies depend on value of the one or more variables and the one or more metrics. The information regarding dependencies comprises a list of variables restricted by each dependency in the contract. The metadata comprises information regarding dependencies between at least one opportunity and one or more provisions in at least one contract, and dependencies between the one or more claim strings in at least one contract. Further, the memory unit stores a set of program modules.

At step 320 one or more preliminary metrics associated with at least one claim string are generated by the processor via the model generator module. Further, the model generator module formulates at least one dependency between the one or more claim strings in at least one contract, based on the mathematical model. The model generator module sends the formulated dependencies into the database for storage. Further, the model generator module identifies at least one preliminary metric representing dependencies between at least one opportunity and one or more provisions in at least one contract.

At step 325, a mathematical model of the one or more provisions of at least one contract is generated by the processor via the model generator module. The mathematical model of represents value of the contract in terms of the one or more preliminary metrics.

At step 330 a set of optimal monetary charges corresponding to the plurality of monetary charges are generated by the processor via the model generator module, based on the mathematical model.

At step 335, at least one monetary charge among the plurality of monetary charges are categorized as one of fraudulent charge and genuine charge, by the processor via a fraud detection module. The fraud detection module compares each monetary charge among the plurality of monetary charges with a corresponding optimal monetary charge in the set of optimal monetary charges.

At step 340, a fraudulent charge metric representing the plurality of monetary charges, is generated, by the processor via a quantifier module, based on the plurality of monetary charges being the fraudulent charge. A mathematical analyzer module calculates portfolio effects based on the dependencies between the one or more claim strings in at least one contract. Further, the mathematical analyzer module calculates false claim law effects based on the fraudulent charge metric.

The method 300 ends at step 345.

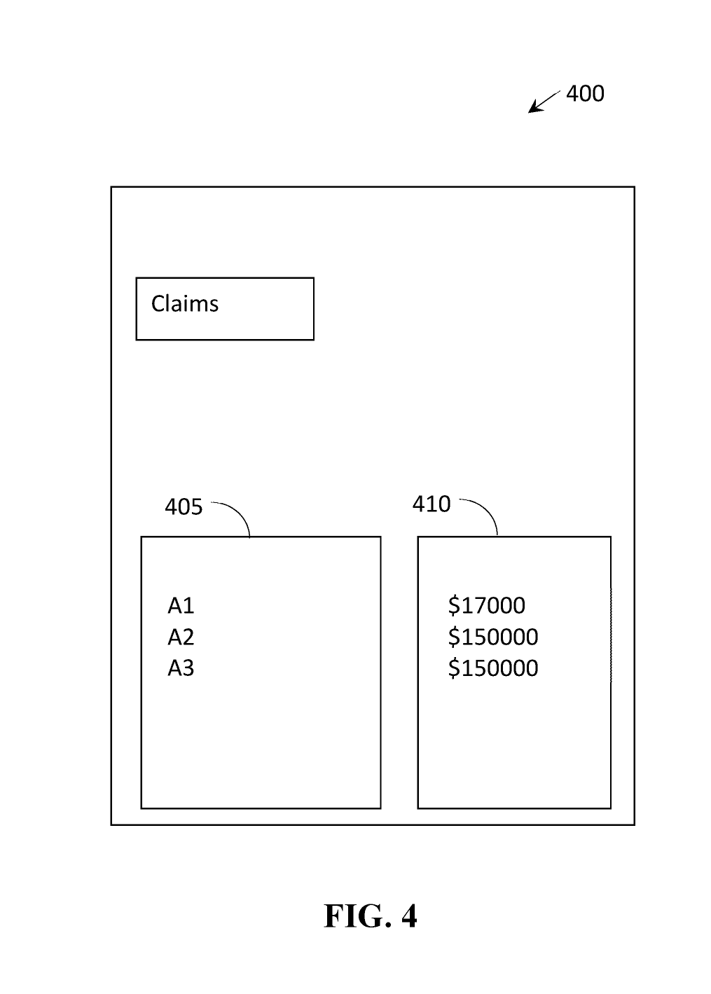

FIG. 4 is a screenshot view of a claim statement screen 400 according to yet another embodiment of the present invention. The claim statement screen 400 comprises a description box 405 and a monetary charge box 410. The description box 405 displays a list of professional services performed by a first party for a second party. In one example, the list comprises A1, A2, and A3. The monetary charge box 410 displays corresponding charges.

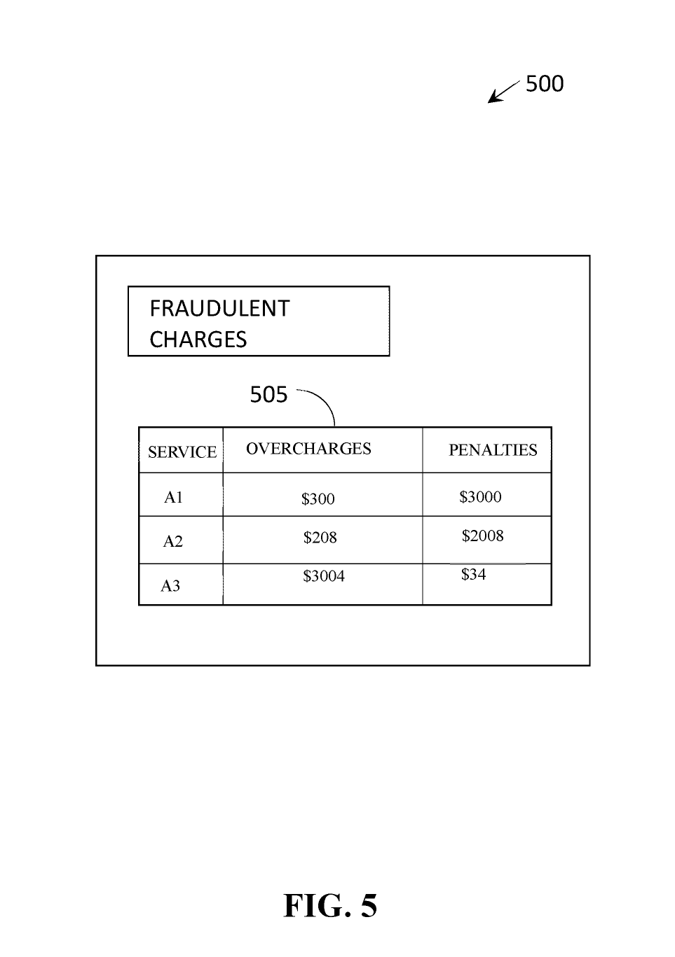

FIG. 5 is a screenshot view of a fraudulent charges screen 500 according to yet another embodiment of the present invention. The fraudulent charges screen 500 comprises a table 505 as displayed to a user. The table 505 comprises information about a plurality of fraudulent charges identified by a fraud detection module. The information comprises service provided, fraudulent overcharges and penalties.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for quantifying fraudulent overcharges and penalties in a claim statement, the system comprising:
a memory unit to store:
a database comprising metadata pertaining to at least one contract, and
a set of program modules,
wherein the metadata comprises information regarding:
dependencies between at least one opportunity and one or more provisions in at least one contract,
dependencies between the one or more claim strings in at least one contract, and
dependencies between the one or more claim strings in at least one statement;
a processor to execute the set of program modules, wherein the set of program modules comprises:
a parser module, executed by the processor, configured to:
parse the contract into at least one claim string, and
parse the claim statement into a plurality of monetary charges;
a model generator module, executed by the processor, configured to:
analyze at least one claim string based on the metadata pertaining to at least one contract,
generate one or more preliminary metrics associated with at least one claim string based on analysis,
generate a mathematical model of the one or more provisions of at least one contract, based on the one or more preliminary metrics, and
generate a set of optimal monetary charge corresponding to the plurality of monetary charges, based on the mathematical model;
a fraud detection module, executed by the processor, configured to categorize at least one monetary charge among the plurality of monetary charges as one of fraudulent charge and non-fraudulent charge based on the plurality of monetary charges exceeding the optimal monetary charge; and
a quantifier module, executed by the processor, configured to generate a fraudulent charge metric representing the fraudulent charge, based on the plurality of monetary charges being the fraudulent charge.

2. The system of claim 1, wherein the opportunity is at least one a business deal, product, a distribution channel, a customer service, a building lease, and a logistics service.

3. The system of claim 1, wherein the one or more provisions comprise at least one of penalties, monetary charges, term of contract, name of parties, a description origin, a compliance origin, structured information pertaining to at least one contract, unstructured information pertaining to at least one contract, comparisons between the one or more provisions, a value model field, a compliance filter trigger, a false claim model filter, a damages scenarios model.

4. The system of claim 1, wherein the claim statement is at least one of invoices, billing payments, reports, account reviews, statement of works, IT professional services, monthly invoices, services optimization reports, utilization reports, account reviews and recommendations, stewardship reports, statement of works.

5. The system of claim 1, further comprising a mathematical analyzer module, executed by the processor, configured to analyze:
portfolio effects based on the dependencies between the one or more claim strings in at least one contract, and
false claim law effects based on the fraudulent charge metric.

6. The system of claim 1, wherein the model generator module identifies at least one preliminary metric representing dependencies between at least one opportunity and one or more provisions in at least one contract.

7. The system of claim 1, wherein dependencies between the one or more claim strings in at least one contract are at least one of a constraint-type dependency and a dependence-type dependency.

8. The system of claim 5, wherein the model generator module formulates at least one dependency between the one or more claim strings in at least one contract, based on the mathematical model.

9. The system of claim 1, wherein the set of program modules are implemented in a network of Application Specific Integrated Circuit (ASIC) Chipsets in the system.

10. A computer implemented method of quantifying fraudulent overcharges and penalties in a claim statement, comprising:
storing metadata pertaining to at least one contract in a computer system, wherein the metadata comprises information pertaining to:
dependencies between at least one opportunity and one or more provisions in at least one contract,
dependencies between the one or more claim strings in at least one contract, and
dependencies between the one or more claim strings in at least one statement;
parsing, by a processor via a parser module, the contract into at least one claim string;
parsing, by the processor via the parser module, the claim statement into a plurality of monetary charges;
analyzing, by the processor via a model generator module, at least one claim string based on the metadata pertaining to at least one contract;
generating, by the processor via the model generator module, one or more preliminary metrics associated with at least one claim string based on analysis;
generating, by the processor via the model generator module, a mathematical model of the one or more provisions of at least one contract, based on the one or more preliminary metrics;
generating, by the processor via the model generator module, a set of optimal monetary charges corresponding to the plurality of monetary charges, based on the mathematical model;
categorizing, by the processor via a fraud detection module, at least one monetary charge among the plurality of monetary charges as one of fraudulent charge and genuine charge, based on the plurality of monetary charges exceeding the optimal monetary charge; and
generating, by the processor via a quantifier module, a fraudulent charge metric representing the plurality of monetary charges, based on the plurality of monetary charges being the fraudulent charge.

11. The method of claim 10, wherein the opportunity is at least one a business deal, product, a distribution channel, a customer service, a building lease, and a logistics service.

12. The method of claim 10, wherein the one or more provisions comprise at least one of penalties, monetary charges, term of contract, name of parties, a description origin, a compliance origin, structured information pertaining to at least one contract, unstructured information pertaining to at least one contract, comparisons between the one or more provisions, a value model field, a compliance filter trigger, a false claim model filter, a damages scenarios model.

13. The method of claim 10, wherein the claim statement is at least one of invoices, billing payments, reports, account reviews, statement of works, IT professional services, monthly invoices, services optimization reports, utilization reports, account reviews and recommendations, stewardship reports, statement of works, and pricing audits.

14. The method of claim 10, further comprising a mathematical analyzer module, executed by the processor, configured to analyze:
analyzing, by the processor via a mathematical analyzer module, portfolio effects based on the dependencies between the one or more claim strings in at least one contract, and
analyzing, by the processor via a mathematical analyzer module, false claim law effects based on the fraudulent charge metric.

15. The method of claim 10, wherein the model generator module identifies at least one preliminary metric representing dependencies between at least one opportunity and one or more provisions in at least one contract.

16. The method of claim 10, wherein dependencies between the one or more claim strings in at least one contract are at least one of a constraint-type dependency and a dependence-type dependency.

17. The method of claim 10, wherein the model generator module formulates at least one dependency between the one or more claim strings in at least one contract, based on the mathematical model.

18. A non-transitory program storage device readable by computer, and comprising a program of instructions executable by a processor to perform a computer implemented method of quantifying fraudulent overcharges and penalties in a claim statement, comprising:
storing metadata pertaining to at least one contract in a computer system, wherein the metadata comprises information pertaining to:
dependencies between at least one opportunity and one or more provisions in at least one contract, and
dependencies between the one or more claim strings in at least one contract;
parsing, by a processor via a parser module, the contract into at least one claim string;
parsing, by the processor via the parser module, the claim statement into plurality of monetary charges;
evaluating, by the processor via a model generator module, at least one claim string based on the metadata pertaining to at least one contract;
generating, by the processor via the model generator module, one or more preliminary metrics associated with at least one claim string based on evaluation;
generating, by the processor via the model generator module, a mathematical model of the one or more provisions of at least one contract, based on the one or more preliminary metrics;
generating, by the processor via the model generator module, an optimal monetary charge, based on the mathematical model;
categorizing, by the processor via a fraud detection module, the plurality of monetary charges as one of fraudulent charge and genuine charge, based on the plurality of monetary charges exceeding the optimal monetary charge; and
generating, by the processor via a quantifier module, a fraudulent charge metric representing the plurality of monetary charges, based on the plurality of monetary charges being the fraudulent charge.
